(19) United States
(12) Patent Application Publication
(10) Pub. No.: US 2006/0171645 A1
(43) Pub. Date: Aug. 3, 2006

(54) Optical fiber cable

(75) Inventors: Yoshihiro Kodaka, Kitaibaraki (JP); Takahiro Sato, Hitachi (JP); Ryo Nagai, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Hitachi Cable, Ltd., Tokyo (JP)

(21) Appl. No.: 11/322,284

(22) Filed: Jan. 3, 2006

(30) Foreign Application Priority Data
Jan. 28, 2005 (JP) 2005-021247

(51) Int. Cl. G02B 6/44

(52) U.S. Cl. 385/114

(57) ABSTRACT

An optical fiber cable in which an optical fiber tape unit can be taken out easily from a sheath is disclosed. An optical fiber cable having a substantially rectangular cross section has one or more optical fiber tape units, a sheath for accommodating the optical fiber tape units, the sheath being of a substantially rectangular cross section, a first pair of notches formed at long sides of the cross section of the sheath, a first line connecting the first pair of notches being across the optical fiber tape units, and second and third pairs of notches formed at the long sides and above and below the first pair of notches, second and third lines connecting the second and third pairs of notches not being across the optical fiber tape units.

The present application is based on Japanese Patent Application No. 2005-021247 filed on Jan. 28, 2005, the entire contents of which are incorporated herein by reference.

### BACKGROUND OF THE INVENTION

### Field of the Invention

The present invention relates to optical fiber cable, which is installed in an underground conduit or between ground electric poles and is drawn into a building, a condominium, or a house from the electric pole, in more particularly, to an optical fiber cable, in which layered optical fiber tape units are accommodated in a sheath.

In recent years, a tape layered type optical fiber cable is widely installed in aerial spaces and underground spaces, so as to realize a FTTH (Fiber to The Home) for the purpose of a communication of high speed and large capacity.

FIG. 1 shows a configuration of a conventional optical fiber cable, which is disclosed by Japanese Patent Laid-Open No. 2003-295011 (JP-A-2003-295011). In an optical fiber cable 100 shown in FIG. 1, a pair of tensile strength resistant members 121 comprising a conductive metal wire or a non-conductive metal wire such as glass fiber, plastic, etc. are provided along both of upper and lower sides of two pieces of optical fiber tape units 112 that are layered. An optical element part 118 comprises a pair of the optical fiber tape units 112 and the tensile strength resistant members 121 covered collectively with a sheath 120 made of a thermoplastic resin such as PE, fire-resistant PE, or PVC. In addition, a supporting wire part 119 comprises a supporting wire 125 made of a metal wire, e.g. a steel wire, and a supporting wire part sheath 123 made of a thermoplastic resin such as PE, fire-resistant PE, or PVC for covering the supporting wire 125. The optical element part 118 and supporting wire part 119 are connected in parallel with each other by a constricted neck portion 122. Further, a pair of notches 124 for dividing the optical fiber cable 100 is provided on side faces of the sheath 120 to take out the optical fiber tape units 112.

In accordance with expansion of demand for the FTTH, it has been required to apply a method comprising steps of installing an optical fiber cable, branching the optical fiber cable at an intermediate part, and taking out an optical fiber tape unit from the optical fiber cable (hereinafter, referred as “intermediate post-branching method”). Outline of the intermediate post-branching method is shown in FIGS. 2 and 3. In case of intermediate post-branching an optical fiber cable, a tab 128 for dividing a cable is inserted into a notch 124, and the tab 128 is moved toward a direction indicated by an arrow shown in FIG. 2 to divide the optical fiber cable, and take out an optical fiber tape unit 112.

Further, other conventional optical fibers used for the intermediate post-branching method is disclosed by Japanese Patent Laid-Open Nos. 2003-202471 (JP-A-2003-202471), 2004-117854 (JP-A-2004-117854), and 2004-206008 (JP-A-2004-206008).

However, in the optical fiber cable shown in FIG. 1, there is a disadvantage in that a sheath 120 is not separated from the optical fiber tape unit 112 and remains therein as shown in FIG. 3, so that the optical fiber tape unit 112 cannot be taken out easily.

### SUMMARY OF THE INVENTION

Accordingly, for solving the above problem, it is an object of the present invention to provide an optical fiber cable in which an optical fiber tape unit can be separated properly from a sheath and can be taken out from an optical fiber cable in case of intermediate post-branching of the optical fiber cable.

According to a first feature of the invention, an optical fiber cable, comprises:

one or more optical fiber tape units;

a sheath for accommodating the optical fiber tape units, the sheath being of a substantially rectangular cross section;

a first pair of notches formed at long sides of the cross section of the sheath, a first line connecting the first pair of notches being across the optical fiber tape units; and

second and third pairs of notches formed at the long sides and above and below the first pair of notches, second and third lines connecting the second and third pairs of notches not being across the optical fiber tape units.

According to a second feature of the invention, the first to third pairs of notches may be formed to provide the first to third lines which are parallel to each other in parallel to a short side of the cross section of the sheath.

According to a third feature of the invention, the first to third pairs of notches may be formed symmetrically at the long sides of the cross section of the sheath.

According to a fourth feature of the invention, it is preferable that a depth of the first pair of notches is equal to or greater than a depth of the second and third pairs of notches.

According to a fifth feature of the invention, the optical fiber cable may further comprise an interposing member accommodated in a space between the optical fiber tape unit and the sheath.

According to a sixth feature of the invention, the optical fiber cable may further comprise an interposing member accommodated in a space between more than two pieces of the optical fiber tape units.

According to a seventh feature of the invention, the interposing member may have a strip shape.

According to an eighth feature of the invention, it is preferable that the interposing member having the strip shape is a polyester based tape.

According to a ninth feature of the invention, the interposing member may have a fiber shape.

According to a tenth feature of the invention, it is preferable that the interposing member having the fiber shape is an aramid fiber.

According to an eleventh feature of the invention, the optical fiber cable may further comprise one or two tensile strength resistant members accommodated in the sheath.

According to a twelfth feature of the invention, the optical fiber tape unit may comprise a plurality of optical fiber cores disposed in parallel and a joint member for connecting a plurality of the optical fiber cores, and each of the optical fiber cores may comprise an optical fiber colored strand having a colored layer as an outermost layer and an over coating layer formed on the optical fiber colored strand to have an outer diameter of 0.4 mm or more.

According to a thirteenth feature of the invention, the optical fiber tape unit may be provided with a concave portion between adjacent optical fiber cores.

According to a fourteenth feature of the invention, an optical fiber cable, comprises:

one or more optical fiber tape units;

a sheath for accommodating the optical fiber tape units, the sheath being of a substantially rectangular cross section;

a first pair of notches formed at long sides of the cross section of the sheath, a first line connecting the first pair of notches being across the optical fiber tape units;

second and third pairs of notches formed at the long sides and above and below the first pair of notches, second and third lines connecting the second and third pairs of notches not being across the optical fiber tape units; and

a supporting wire part including a supporting wire and a supporting wire part sheath provided at an outer periphery of the supporting wire.

According to a fifteenth feature of the invention, the supporting wire part may be connected to the sheath via a necked portion continuously.

According to a sixteenth feature of the invention, the supporting wire part may be connected to the sheath via a necked portion intermittently.

In a conventional optical fiber cable shown in FIG. 1, when a tab for dividing a cable inserted in a notch is moved, a suppress force of the tab is applied between a sheath and an optical fiber tape unit. This is one of causes that the sheath is not separated from the optical fiber tape unit and remained therein. In particular, when there is a concave portion on a surface of the optical fiber tape unit, the sheath cuts into the concave portion due to the suppress force of the tab. This is also the cause that the sheath is not separated from the optical fiber tape unit and remained therein. In addition, the sheath cuts into the concave portion, so that the optical fiber tape unit is divided into single cores.

In the present invention, (1) a first notch is formed on one or more points where an optical fiber tape unit is provided on a line extending from a tip of the first notch in parallel with short side faces in a cross section of the optical fiber cable, and (2) a second notch is formed on one or more points where the optical fiber tape unit is not provided on a line extending from a tip of the second notch in parallel with the short side faces in the cross section of the optical fiber cable and the second notch is provided on both sides of the first notch. Therefore, when the tab for dividing a cable inserted into the second notch is moved, it is possible to suppress a suppress force of the tab applied between the sheath and the optical fiber tape unit. Further, since a thickness of both side faces of the sheath at a position where the first notch is formed is thinner than a thickness of both side faces of the sheath at a position where the second notch is formed, the sheath cracks at the first notch to be divided. The optical fiber tape unit can be taken out easily from the divided sheath without the sheath being left thereon.

In addition, a configuration of a tool for separation can be simplified by forming the notches on the both of long side faces of the sheath symmetrically on both sides.

Further, the optical fiber cable can be divided more easily by providing a depth of the first notch equal to or greater than a depth of the second notch.

Still further, an interposing member is inserted between the sheath and optical fiber tape unit, or between more than two pieces of the optical fiber tape units. Therefore, even if a slight suppress force or load is applied to the optical fiber tape unit during separation, the interposing member absorbs the suppress force and load, so that the optical fiber tape unit can be properly separated from the sheath. Further, even if a slight strain is applied to the optical fiber tape unit when the optical fiber tape unit 12 is taken out, this stain is absorbed, so that the optical fiber tape unit 12 can be separated from the sheath stably.

The present invention is more effective when an optical fiber tape unit comprising optical fiber cores having an outer diameter increased to be 0.4 mm or more, particularly when an optical fiber tape unit comprising optical fiber cores in which a concave portion is provided between the adjacent cores.

### BRIEF DESCRIPTION OF THE DRAWINGS

Next, preferred embodiment according to the present invention will be explained in conjunction with appended drawings, wherein:

FIG. 1 is a cross sectional view showing a conventional optical fiber cable;

FIG. 2 is a cross sectional view showing a conventional optical fiber cable at the time of post-branching, in which a tab for dividing a cable is inserted into a notch;

FIG. 3 is a cross sectional view showing a conventional optical fiber cable at the time of post-branching, in which the optical fiber cable is divided by moving the tab for dividing a cable inserted into the notch;

FIG. 4 is a cross sectional view showing an optical fiber core used for an optical fiber cable in a first preferred embodiment according to the invention;

FIG. 5 is a cross sectional view showing an optical fiber tape unit used for an optical fiber cable in the first preferred embodiment according to the invention;

FIG. 6 is a cross sectional view showing an optical fiber tape unit used for an optical fiber cable in a second preferred embodiment according to the invention;

FIG. 7 is a cross sectional view showing an optical fiber cable in the first preferred embodiment according to the invention;

FIG. 8 is a cross sectional view showing an optical fiber cable in a second preferred embodiment according to the invention;

FIG. 9 is a cross sectional view showing an optical fiber cable in a third preferred embodiment according to the invention;

FIG. 10 is a cross sectional view showing an optical fiber cable in a fourth preferred embodiment according to the invention;

FIG. 11 is a cross sectional view showing an optical fiber cable in a fifth preferred embodiment according to the invention;

FIG. 12 is a cross sectional view showing an optical fiber cable in a sixth preferred embodiment according to the invention;

FIG. 13 is a cross sectional view showing an optical fiber cable in a seventh preferred embodiment according to the invention;

FIG. 14 is a cross sectional view showing an optical fiber cable in an eighth preferred embodiment according to the invention;

FIG. 15 is a cross sectional view showing an optical fiber cable according to the invention at the time of post-branching, in which a tab for dividing a cable is inserted into a notch;

FIG. 16 is a cross sectional view showing an optical fiber cable according to the invention at the time of post-branching, in which the optical fiber cable is divided by moving the tab for dividing a cable inserted into the notch;

FIG. 17 is a cross sectional view showing an optical fiber cable in a ninth preferred embodiment according to the invention;

FIG. 18 is a cross sectional view showing an optical fiber cable in a tenth preferred embodiment according to the invention; and

FIGS. 19A and 19B are diagrams showing side views of the optical fiber cable according to the present invention, wherein FIG. 19A is a side view of the optical fiber in which neck portion is provided continuously and FIG. 19B is a side view of the optical fiber in which neck portion is provided intermittently.

### DESCRIPTION OF THE PREFERRED EMBODIMENTS

Next, the preferred embodiment according to the present invention will be explained in conjunction with the appended drawings.

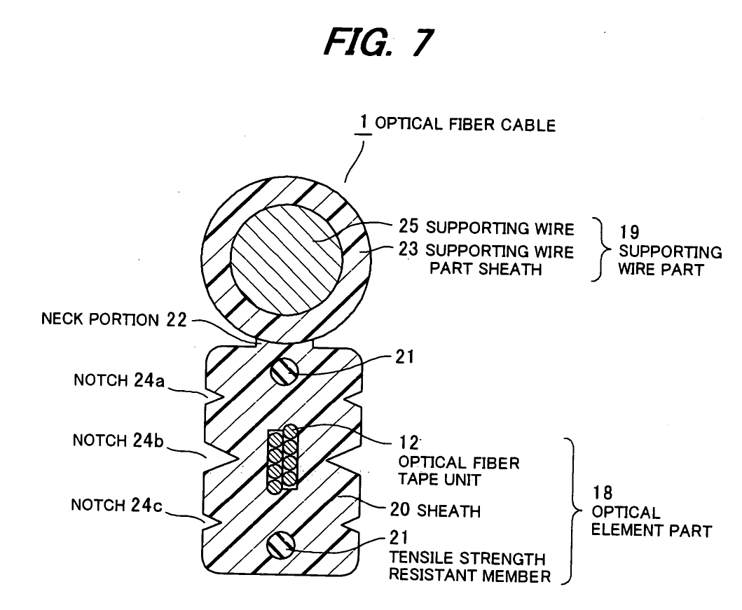

FIG. 7 shows an optical fiber cable in a first preferred embodiment according to the present invention.

An optical fiber cable 1 in the first preferred embodiment shown in FIG. 7 is an optical fiber cable having a substantially rectangular cross section. The optical fiber cable 1 comprises an optical element part 18 and a supporting wire part 19.

The optical element part 18 comprises a sheath 20 accommodating two pieces of optical fiber tape units 12, and two tensile strength resistant members 21 disposed on both sides of the optical fiber tape units 12. The supporting wire part 19 comprises a supporting wire part sheath 23 provided on an outer periphery of a supporting wire 25. The optical element part 18 and supporting wire part 19 are connected by a neck portion 22 continuously or intermittently. Further, notches 24a, 24b, and 24c are formed at three points on both of long side faces of the sheath 20, respectively. The center notch 24b positioned at a center is formed on a point where the optical fiber tape unit 12 is provided on a line extending from a tip of the notch 24b in parallel with short side faces, and the notches 24a, 24c positioned at both ends are formed on points where the optical fiber tape unit is not provided on a line extending from a tip of each of the notch 24a, 24c in parallel with the short side faces.

In other words, a first pair of notches 24b are formed at long sides of the cross section of the sheath 20, and a line connecting the first pair of notches 24 are across the optical fiber units 12, and second and third pairs of notches 24a, 24c formed at the longs sides of the cross section of the sheath 20, and above and below the first pairs of the notches 24b, and a line connecting the pairs of the notches 24a and a line connecting the pairs of the notches 24c are not across the optical fiber tapes units 12. Further, the lines connecting first to third pairs of notches 24b, 24a, and 24c are formed to be parallel with each other and in parallel to short side faces of the cross section of the sheath 20.

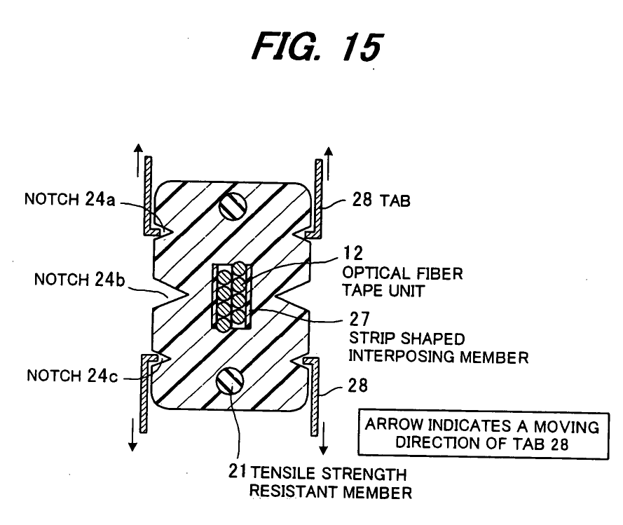

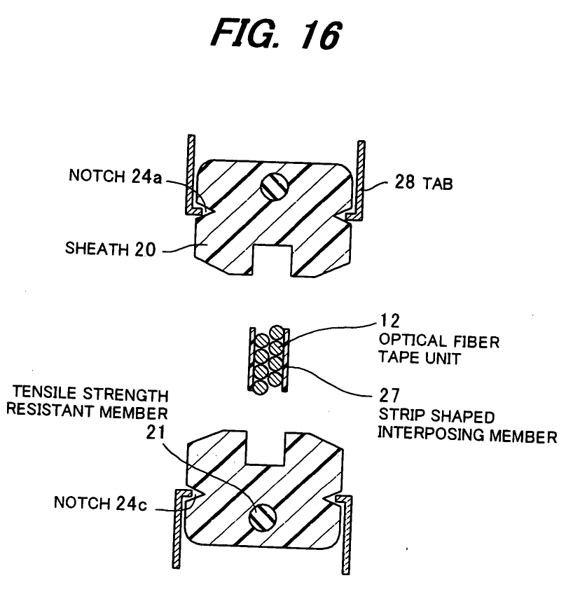

FIGS. 15 and 16 show an outline of an intermediate post-branching method for an optical fiber cable according to the present invention. Tabs 28 for dividing a cable are inserted into the notches 24a, 24c, and the tabs 28 are moved in a direction indicated by an arrow in FIG. 15. In the optical fiber cable of the present invention, optical fiber tape unit is not provided on a line extending from a tip of each of the notches 24a, 24c in parallel with the short side faces, so that the sheath 20 does not cut into a concave portion 29 of the optical fiber tape unit 12 pressed by the suppress force of the tab 28, and the optical fiber cable is torn from the center notch 24b, so that the optical fiber tape unit 12 can be taken out properly.

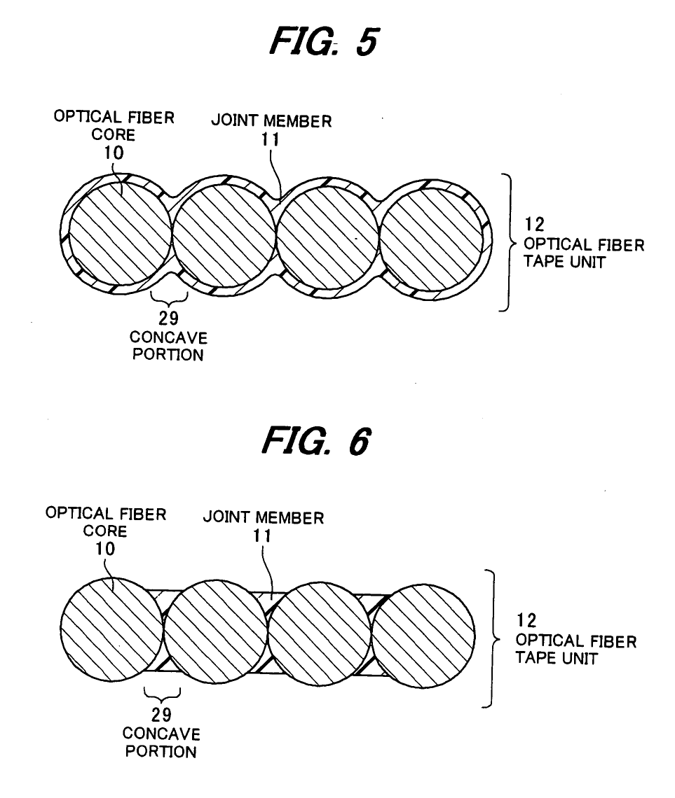

FIG. 5 shows an optical fiber tape unit 12 used for the optical fiber cable 1 in the first preferred embodiment according to the present invention. An optical fiber tape unit 12 in the first preferred embodiment shown in FIG. 5 comprises a plurality of optical fiber cores 10 arranged in parallel with each other and connected with a joint member 11. The optical fiber core 10 comprises an optical fiber colored strand including a colored layer of a colored ultraviolet curing resin as an outermost layer, and an over coating layer of an ultraviolet curing resin provided on the optical fiber colored strand cylindrically to have an outer diameter of 0.4 mm or more. The joint member 11 is provided such that the concave portion 29 is formed between adjacent optical fiber cores 10. As shown in FIG. 6, the optical fiber cores 10 may be connected by the joint member 11 provided only between the adjacent optical fiber cores 10. In FIGS. 5 and 6, the number of optical fiber cores 10 is four, however, the present invention is not limited thereto. For example, the number of optical fiber cores 10 may be eight. Two pieces of the optical fiber tape units may be further coupled by the joint member 11 to provide an optical fiber tape unit.

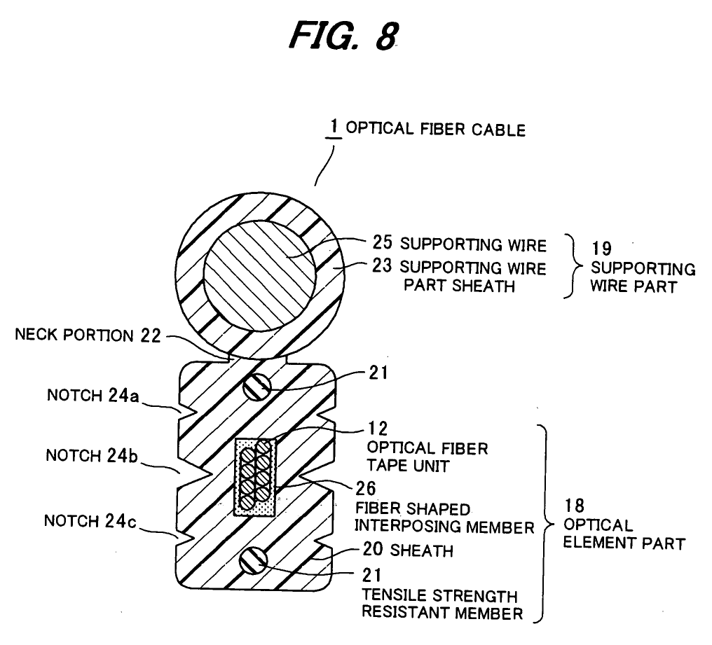

FIGS. 8 to 14, 17 and 18 show an optical fiber cable in second to tenth preferred embodiments according to the present invention.

In the following preferred embodiments, an interposing member is provided. The interposing member may have fiber shape or strip shape. Preferably, the fiber shaped interposing member is composed of aramid fiber and the strip shaped interposing member is composed of polyester based tape.

In an optical fiber cable 1 in a second preferred embodiment shown in FIG. 8, a fiber shaped interposing member 26 is accommodated in a space between two pieces of optical fiber tape units 12 and a sheath 20.

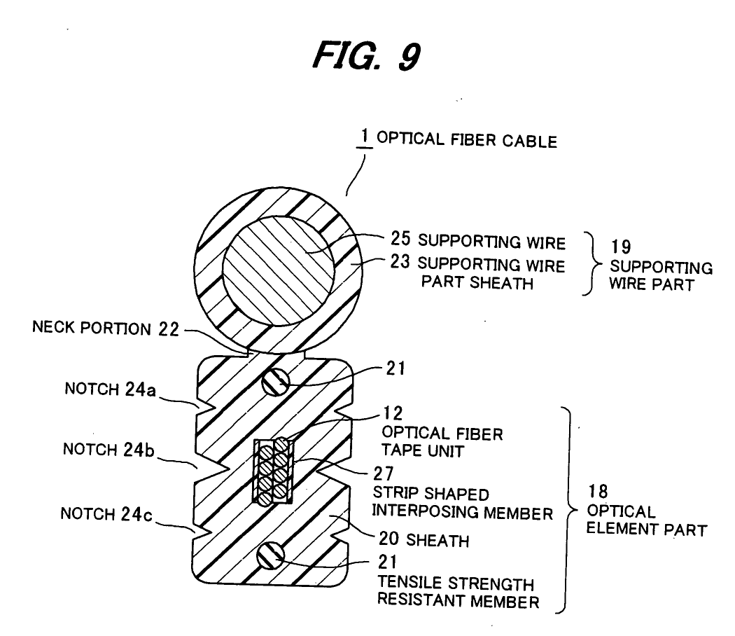

In an optical fiber cable 1 in a third preferred embodiment shown in FIG. 9, strip shaped interposing members 27 are provided at both sides of a space between two pieces of optical fiber tape units 12 and a sheath 20.

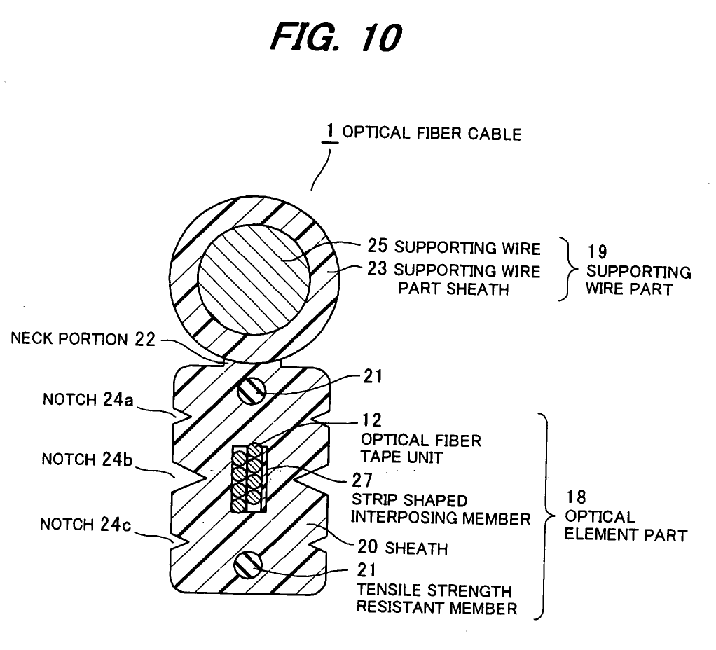

In an optical fiber cable 1 in a fourth preferred embodiment shown in FIG. 10, a strip shaped interposing member 27 is provided at only one side of a space between two pieces of optical fiber tape units 12 and a sheath 20.

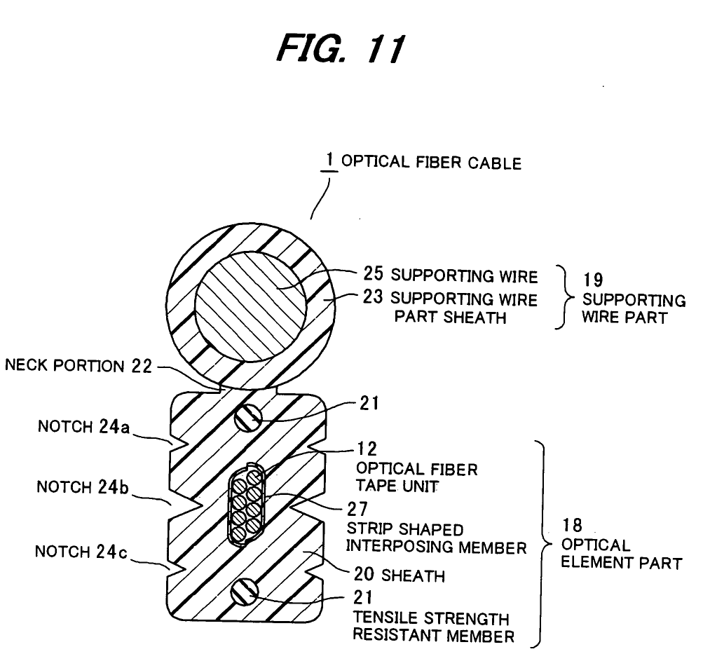

In an optical fiber cable 1 in a fifth preferred embodiment shown in FIG. 11, two pieces of optical fiber tape units 12 covered by strip shaped interposing members 27 are accommodated in a sheath 20.

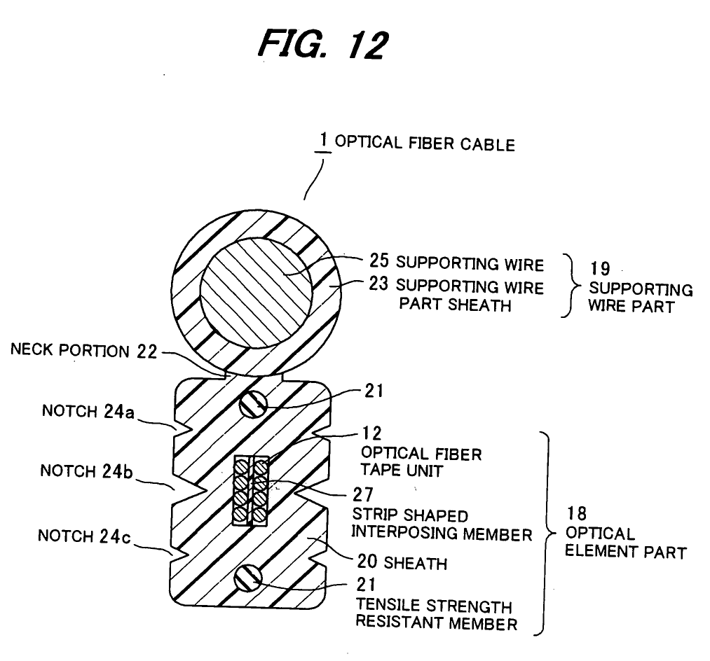

In an optical fiber cable 1 in a sixth preferred embodiment shown in FIG. 12, a strip shaped interposing member 27 is accommodated in a space between two pieces of optical fiber tape units 12.

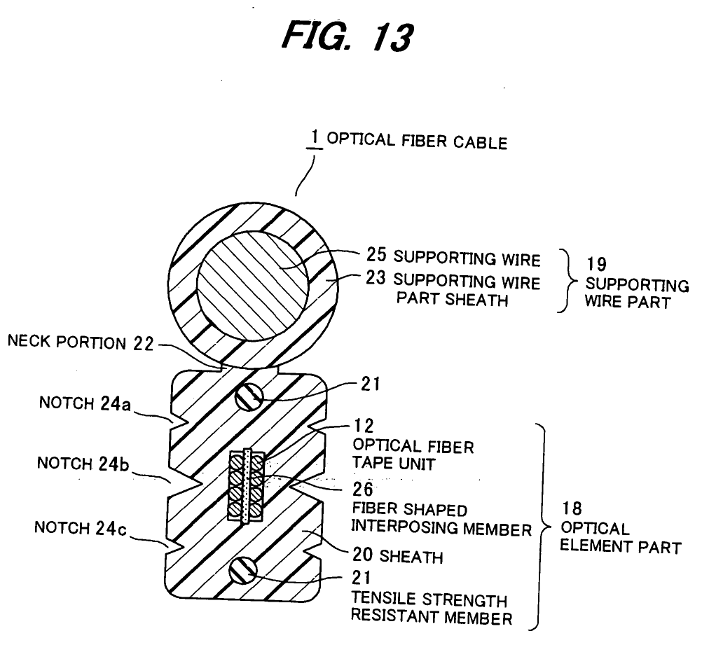

In an optical fiber cable 1 in a seventh preferred embodiment shown in FIG. 13, a fiber shaped interposing member 26 is accommodated in a space between two pieces of optical fiber tape units 12.

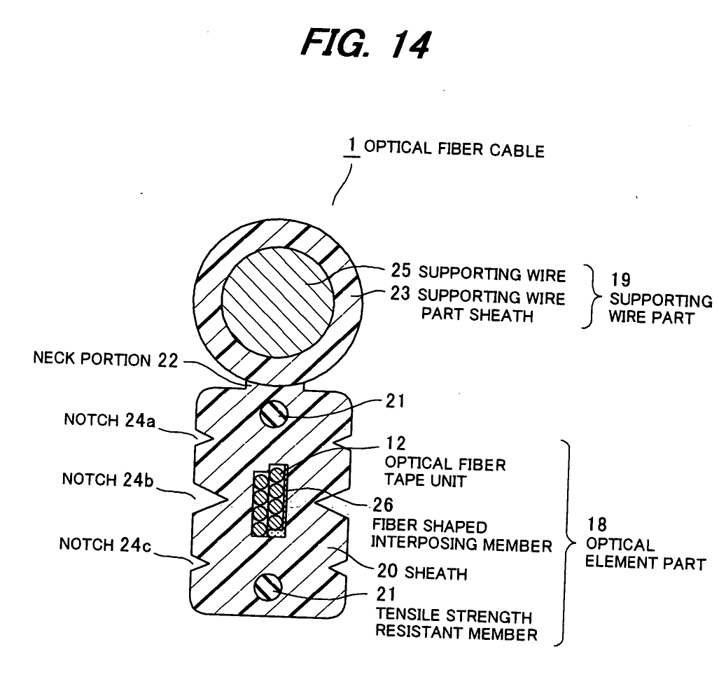

In an optical fiber cable 1 in an eighth preferred embodiment shown in FIG. 14, a fiber shaped interposing member 26 is provided at only one side of a space between two pieces of optical fiber tape units 12 and a sheath 20.

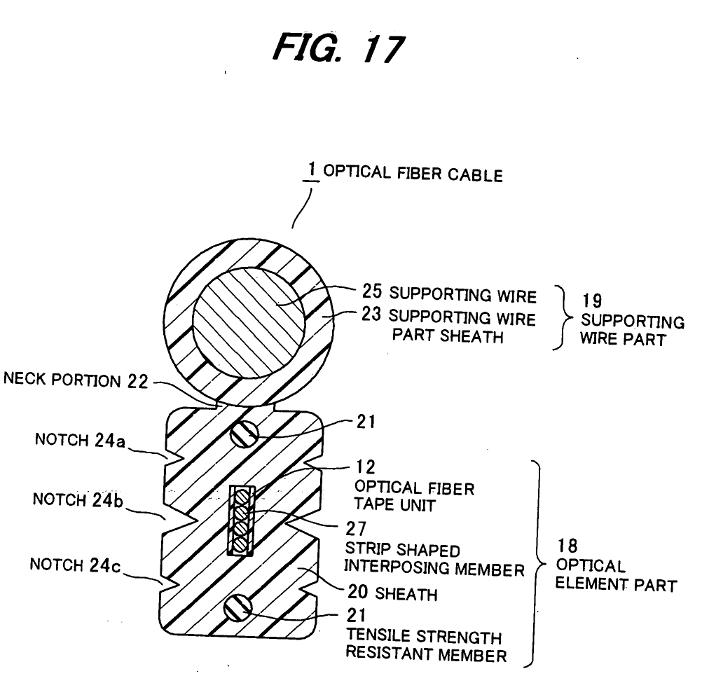

In an optical fiber cable 1 in a ninth preferred embodiment shown in FIG. 17, an optical fiber tape units 12 provided with strip shaped interposing members 27 at both sides thereof is accommodated in a sheath 20.

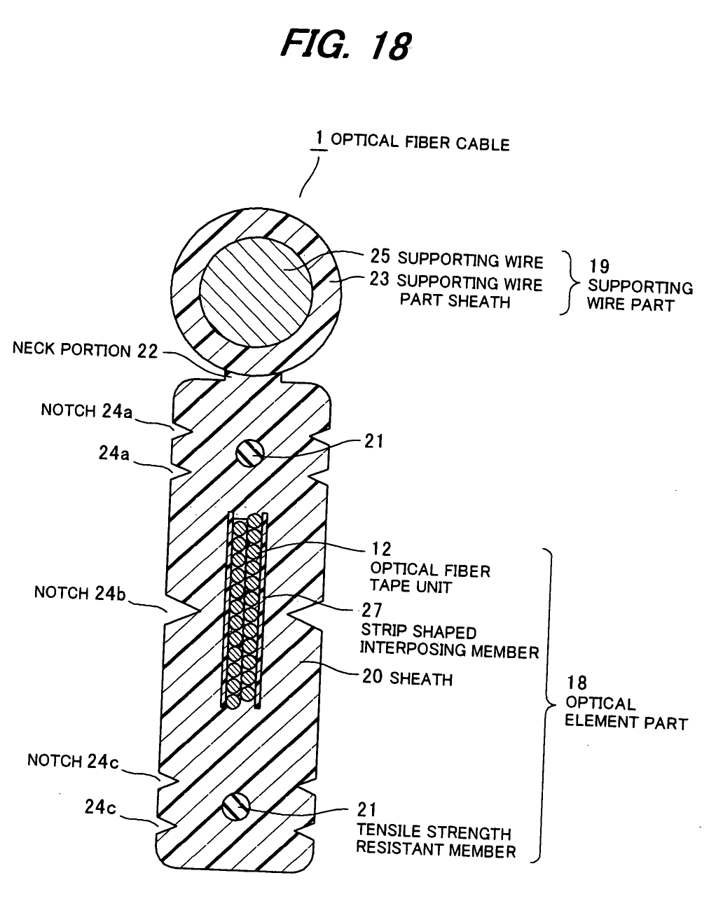

In an optical fiber cable 1 in a tenth preferred embodiment shown in FIG. 18, two pieces of optical fiber tape units 12 provided with strip shaped interposing members 27 at both sides thereof is accommodated in a sheath 20. In a cross section of the optical fiber cable 1, a notch 24b is formed on one point where the optical fiber tape unit 12 is provided on a line extending from a tip of the notch 24b in parallel with short side faces, and notches 24a, 24a and 24c, 24c are formed on two points where the optical fiber tape unit 12 is not provided on a line extending from a tip of each of the notches 24a, 24a and 24c, 24c in parallel with the short side faces on both sides of the notch 24b. The notches 24a, 24a, 24b, and 24c, 24c are formed at five points in total on both of long side faces of the optical element part 18 of the optical fiber cable 1.

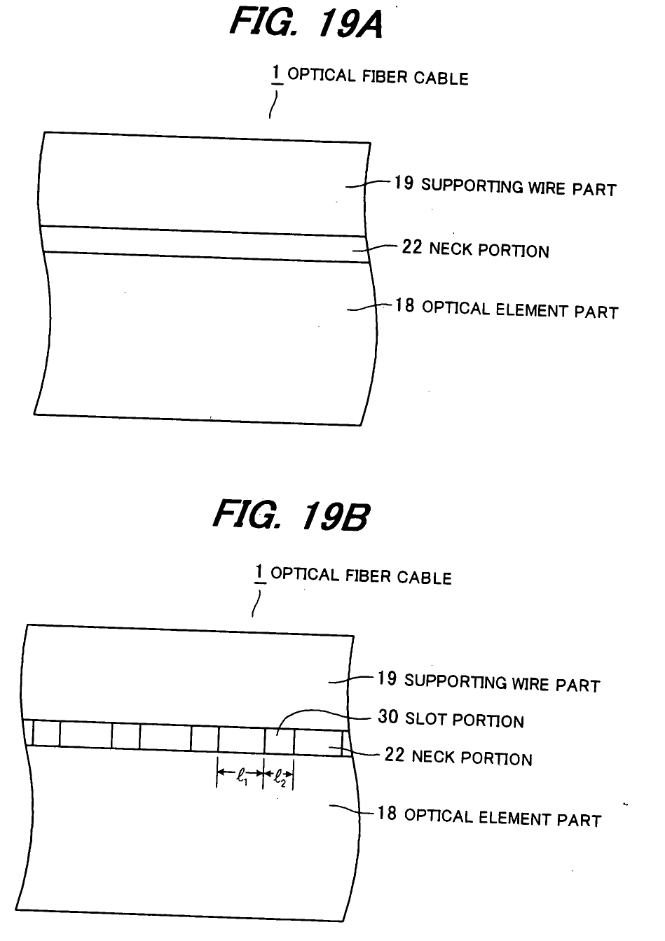

FIGS. 19A and 19B show side views of the optical fiber cable 1 according to the present invention, wherein FIG. 19A is a side view of the optical fiber in which the neck portion 22 is provided continuously and FIG. 19B is a side view of the optical fiber in which the neck portions 22 are provided intermittently. As shown in FIG. 19A, the supporting wire part 19 is connected to the sheath 20 of the optical element part 18 via the neck portion 22 continuously. As shown in FIG. 19B, the supporting wire part 19 may be connected to the sheath 20 via the neck portions 22 intermittently, namely slot portions 30 each having a width 12 are provided between the neck portions 22 each having a width

### Embodiment

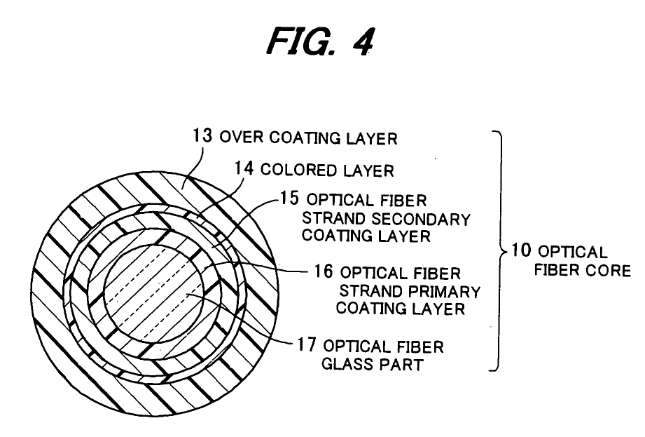

In the embodiment, as shown in FIG. 4, an optical fiber core 10 comprises an optical fiber glass part 17 having an outer diameter of about 0.125 mm, an optical fiber strand primary coating layer 16 and an optical fiber strand secondary coating layer 15, each of which is composed of an ultraviolet curing resin for covering the optical fiber glass part 17 to have an outer diameter of about 0.245 mm. In addition, the optical fiber strand secondary coating layer 15 is coated by a colored layer 14 composed of an ultraviolet curing resin to have an outer diameter of about 0.255 mm, and further the colored layer 14 is coated by an over coating layer 13 composed of an ultraviolet curing resin to have an outer diameter of about 0.50 mm.

The optical fiber tape 12 in this embodiment comprises, as shown in FIG. 5, the optical fiber cores 10 are connected by a joint member 11 composed of an ultraviolet curing resin. As to regard an overall dimension of the optical fiber tape unit 12, a long diameter is about 2.05 mm and a short diameter is about 0.52 mm.

In the optical fiber cable 1 of this embodiment, two pieces of the optical fiber tape units 12 are arranged as shown in FIG. 9, and a pair of tensile strength resistant members 21, each of which comprises galvanized steel wire having a diameter of 0.4 mm, are disposed at upper and lower sides of the optical fiber tape units 12. One piece of polyester tape (strip shaped interposing member) 27 with a width of 2.5 mm and a thickness of 0.025 mm is provided at each of left and right sides of the optical fiber tape units 12. The optical fiber tape units 12, polyester tapes 27 and tensile strength resistant members 21 are jacketed collectively with a sheath 20 comprising a low-density polyethylene resin, to provide an optical element part 18. A supporting wire 25 comprising a galvanized steel wire with a diameter of 2.3 mm is jacketed with a supporting wire part sheath 23 comprising a low-density polyethylene resin, to provide a supporting wire part 19. The optical element part 18 and the supporting wire part 19 are disposed in parallel with each other and connected with each other by a constricted neck portion 22.

In addition, on both of long side faces of the sheath 20, notches 24a, 24b, and 24c are provided at three points on both sides of the sheath 20 for tearing up the optical fiber cable 1 for taking out the optical fiber tape units 12. At this time, the notches 24a, 24c provided at both ends of both long side faces are formed symmetrically on both sides, where the optical fiber tape unit 12 is not provided on a line extending from a tip of each of the notches 24a, 24c in parallel with the short side faces. Simultaneously, the notch 24b provided at a center of both sides is formed on one point where an optical fiber tape unit 12 is provided on a line extending from a tip of the notch 24b in parallel with short side faces. As to regard the respective dimension of the notches, the notch 24a and 24c have a depth of 0.5 mm and a width of 0.5 mm, respectively, and the notch 24b has a depth of 0.8 mm and a width of 0.7 mm. As to a total dimension of the optical fiber cable 1, the optical fiber cable 1 has a height of about 9 mm and a width of about 3.3 mm.

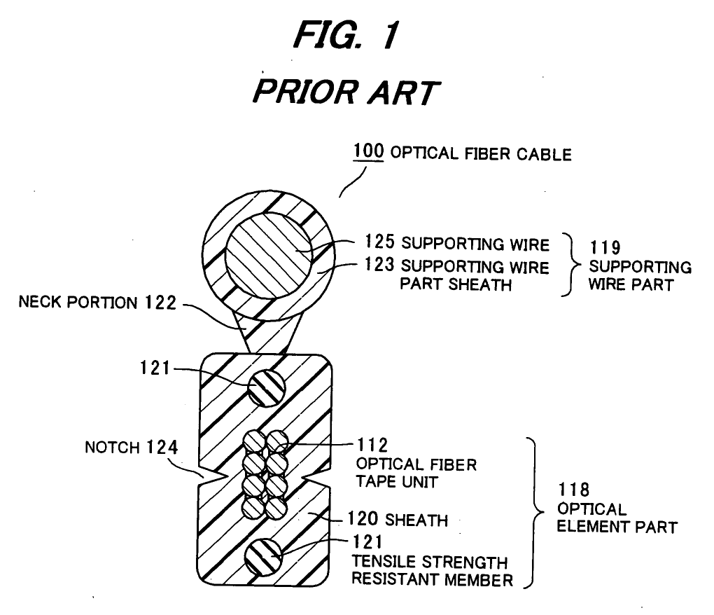

Next, a test of taking out the optical fiber tape unit (intermediate post-branching test) was conducted by using the conventional optical fiber cable shown in FIG. 1 and optical fiber cables in preferred embodiments according to the present invention shown in FIGS. 7 to 14.

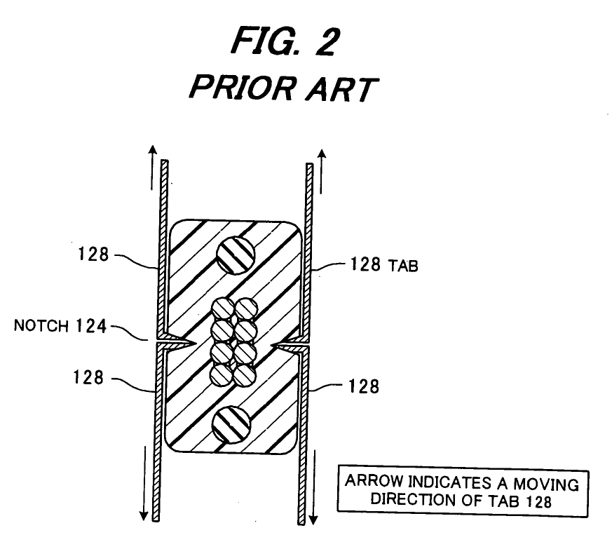

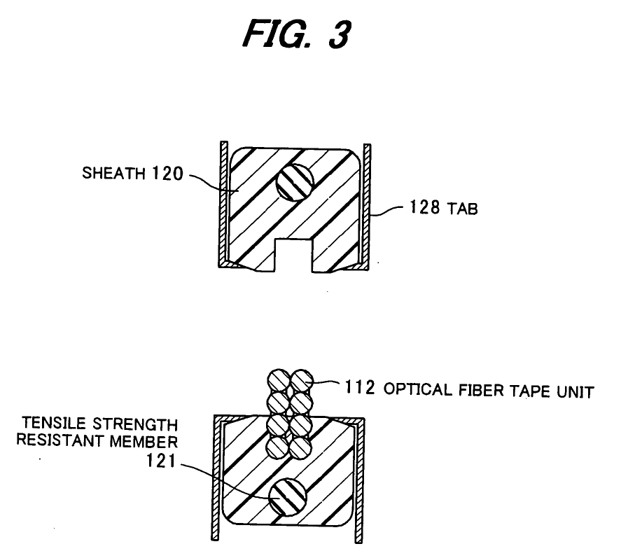

FIGS. 2, 3, 15 and 16 show an outline of the test of taking out the optical fiber tape unit from the optical fiber cable. A case of intermediate post-branching of the conventional optical fiber cable shown in FIG. 1 is already explained in the background of the invention of this application. In case of intermediate post-branching of the optical fiber cables shown in FIGS. 7 to 14, the tab 28 for dividing a cable is inserted into the notches 24a, 24c, and the tab 28 is moved toward a direction for dividing the cable, the sheath 20 is torn at the notch 24b to take out the optical fiber tape unit 12 from the sheath 20. An acceptance/rejection criterion in this test is as to whether the optical fiber tape unit 12 is not remained in the sheath 20. Namely, when the optical fiber tape unit 12 is not remained in the sheath 20, the optical fiber cable is judged as accepted.

TABLE 1 shows a result of the intermediate post-branching test. From this result, it is confirmed that the operativity for taking out the optical fiber tape unit 12 in the conventional optical fiber cable is significantly bad. On the other hand, it is confirmed that the optical fiber cable of the present invention is excellent in the operativity for taking out the optical fiber tape unit 12.

TABLE 1

| | | | Number of | Rate of |
|---|---|---|---|---|
| Sample | Figure No. of | Number of tests | acceptances | acceptance |
| No. | cross section | (times) | (times) | (%) |
| 1 | | 50 | 48 | 96 |
| 2 | | 50 | 50 | 100 |
| 3 | | 50 | 50 | 100 |
| 4 | | 50 | 50 | 100 |
| 5 | | 50 | 50 | 100 |
| 6 | | 50 | 50 | 100 |
| 7 | | 50 | 50 | 100 |
| 8 | | 50 | 50 | 100 |
| 9 | | 50 | 2 | 4 |
| | (conventional) | | | |

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching herein set forth.

1. An optical fiber cable, comprising:
one or more optical fiber tape units;
a sheath for accommodating the optical fiber tape units, the sheath being of a substantially rectangular cross section;
a first pair of notches formed at long sides of the cross section of the sheath, a first line connecting the first pair of notches being across the optical fiber tape units; and
second and third pairs of notches formed at the long sides and above and below the first pair of notches, second and third lines connecting the second and third pairs of notches not being across the optical fiber tape units.

2. The optical fiber cable, according to claim 1, wherein:
the first to third pairs of notches are formed to provide the first to third lines which are parallel to each other in parallel to a short side of the cross section of the sheath.

3. The optical fiber cable, according to claim 1, wherein:
the first to third pairs of notches are formed symmetrically at the long sides of the cross section of the sheath.

4. The optical fiber cable, according to claim 1, wherein:
a depth of the first pair of notches is equal to or greater than a depth of the second and third pairs of notches.

5. The optical fiber cable, according to claim 1, further comprising:
an interposing member accommodated in a space between the optical fiber tape unit and the sheath.

6. The optical fiber cable, according to claim 1, further comprising:
an interposing member accommodated in a space between more than two pieces of the optical fiber tape units.

7. The optical fiber cable, according to claim 5 or +, wherein:
the interposing member has a strip shape.

8. The optical fiber cable, according to claim 7, wherein:
the interposing member having the strip shape is a polyester based tape.

9. The optical fiber cable, according to claim 5, wherein:
the interposing member has a fiber shape.

10. The optical fiber cable, according to claim 9, wherein:
the interposing member having the fiber shape is an aramid fiber.

11. The optical fiber cable, according to claim 1, further comprising:
one or two tensile strength resistant members accommodated in the sheath.

12. The optical fiber cable, according to claim 1, wherein:
the optical fiber tape unit comprises a plurality of optical fiber cores disposed in parallel and a joint member for connecting a plurality of the optical fiber cores, and
each of the optical fiber cores comprises an optical fiber colored strand having a colored layer as an outermost layer and an over coating layer formed on the optical fiber colored strand to have an outer diameter of 0.4 mm or more.

13. The optical fiber cable, according to claim 12, wherein:
the optical fiber tape unit is provided with a concave portion between adjacent optical fiber cores.

14. An optical fiber cable, comprising:
one or more optical fiber tape units;
a sheath for accommodating the optical fiber tape units, the sheath being of a substantially rectangular cross section;
a first pair of notches formed at long sides of the cross section of the sheath, a first line connecting the first pair of notches being across the optical fiber tape units;
second and third pairs of notches formed at the long sides and above and below the first pair of notches, second and third lines connecting the second and third pairs of notches not being across the optical fiber tape units; and
a supporting wire part including a supporting wire and a supporting wire part sheath provided at an outer periphery of the supporting wire.

15. The optical fiber cable, according to claim 14, wherein:
the supporting wire part is connected to the sheath via a necked portion continuously.

16. The optical fiber cable, according to claim 14, wherein:
the supporting wire part is connected to the sheath via a necked portion intermittently.

17. The optical fiber cable, according to claim 6, wherein:
the interposing member has a strip shape.

18. The optical fiber cable, according to claim 6, wherein:
the interposing member has a fiber shape.
